(19) United States
(12) Patent Application Publication
(10) Pub. No.: US 2009/0259948 A1
(43) Pub. Date: Oct. 15, 2009

(54) SURROGATE AVATAR CONTROL IN A VIRTUAL UNIVERSE

(76) Inventors: Rick A. Hamilton II, Charlottesville, VA (US); Paul A. Moskowitz, Yorktown Heights, NY (US); Brian M. O'Connell, Cary, NC (US); Clifford A. Pickover, Yorktown Heights, NY (US); Keith R. Walker, Austin, TX (US)

Correspondence Address: HOFFMAN WARNICK LLC, 75 STATE ST, 14TH FLOOR, ALBANY, NY, 12207, US

(21) Appl. No.: 12/103,186

(22) Filed: Apr. 15, 2008

(51) Int. Cl. G06F 3/048

(52) U.S. Cl. 715/757

(57) ABSTRACT

The present invention is directed to providing surrogate avatar control in a virtual universe. The invention enables one resident of the virtual universe to take over the avatar of a second resident. A method for controlling an avatar may include providing the avatar in the virtual universe, where the avatar is controlled by a first entity and then supplying a token that allows for permission for a second entity to control some aspect of the first entity's avatar.

### FIELD OF THE INVENTION

The present invention relates generally to improving the avatar experience in a virtual universe, and more specifically relates to providing surrogate avatar control in a virtual universe.

### BACKGROUND OF THE INVENTION

A virtual environment is an interactive simulated environment accessed by multiple users through an online interface. Users inhabit and interact in the virtual environment via avatars, which are two or three-dimensional graphical representations of humanoids. There are many different types of virtual environments, however there are several features many virtual environments generally have in common:

A) Shared Space: the world allows many users to participate at once.
B) Graphical User Interface: the environment depicts space visually, ranging in style from 2D “cartoon” imagery to more immersive 3D environments.
C) Immediacy: interaction takes place in real time.
D) Interactivity: the environment allows users to alter, develop, build, or submit customized content.
E) Persistence: the environment's existence continues regardless of whether individual users are logged in.
F) Socialization/Community: the environment allows and encourages the formation of social groups such as teams, guilds, clubs, cliques, housemates, neighborhoods, etc.

An avatar can have a wide range of business and social experiences. Such business and social experiences are becoming more common and increasingly important in on-line virtual environments (e.g., universes, worlds, etc.), such as that provided in the on-line world Second Life (Second Life is a trademark of Linden Research in the United States, other countries, or both). The Second Life client program provides its users (referred to as residents) with tools to view, navigate, and modify the Second Life world and participate in its virtual economy.

Second Life and other on-line virtual environments present a tremendous new outlet for both structured and unstructured virtual collaboration, gaming, exploration, commerce, and travel, as well as real-life simulations in virtual spaces. As the virtual universe expands so does the availability and opportunity for avatars to attend different events.

Currently an individual who participates in a virtual universe is responsible for personally activating and controlling their individually assigned avatar. Virtual universes have also become more complex as processing power, memory storage, and bandwidth have increased, and opportunities for multi-avatar events, such as business meetings, lecture, and social gatherings have increased. A real-world resident who also has an avatar is finding that they are faced with the situation that he/she is obligated to attend multiple events in the virtual universe that may occur simultaneously. Similarly, the real-world resident may also find conflicts between an event(s) in the real-world that occurs simultaneously with one or more events in the virtual universe.

Similarly, if an avatar is running, for example a 24-hour business (e.g., service, store, etc.) in the virtual universe, the real-life person controlling the avatar will have to have time to sleep, run another business, and perform other real-life activities. Another shortcoming is the situation where an avatar may have to wait in a long line in a virtual universe (e.g., at a large event, business, etc.) and the real-life person may wish to have alternatives that allow him/her to leave the avatar during the wait.

Accordingly, there is an opportunity to improve upon the existing virtual universe experience.

### SUMMARY OF THE INVENTION

The present invention is directed to providing surrogate avatar control in a virtual universe.

A first aspect of the present invention is directed to a method for controlling an avatar in a virtual universe, comprising: providing an avatar in a virtual universe, wherein the avatar is controlled by a first entity; and supplying a token, wherein the token comprises a permission for a second entity to control an aspect of the avatar.

A second aspect of the present invention is directed to a system for controlling an avatar in a virtual universe, comprising: a component for providing an avatar in a virtual universe, wherein the avatar is controlled by a first entity; and a component for supplying a token, wherein the token comprises a permission for a second entity to control an aspect of the avatar.

A third aspect of the present invention is directed to a program product stored on a computer readable medium, which when executed, controls an avatar in a virtual universe, the computer readable medium comprising program code for: providing an avatar in a virtual universe, wherein the avatar is controlled by a first entity; and supplying a token, wherein the token comprises a permission for a second entity to control an aspect of the avatar.

A fourth aspect of the present invention is directed to a method for deploying an application for controlling an avatar in a virtual universe comprising: providing a computer infrastructure being operable to: provide an avatar in a virtual universe, wherein the avatar is controlled by a first entity; and supply a token, wherein the token comprises a permission for a second entity to control an aspect of the avatar.

The illustrative aspects of the present invention are designed to solve the problems herein described and other problems not discussed.

### BRIEF DESCRIPTION OF THE DRAWINGS

These and other features of this invention will be more readily understood from the following detailed description of the various aspects of the invention taken in conjunction with the accompanying drawings.

FIG. 1 depicts a high-level schematic diagram showing a networking environment for providing a virtual universe in accordance with an embodiment of the present invention.

FIG. 2 depicts a more detailed view of a virtual region shown in the virtual universe of FIG. 1 in accordance with an embodiment of the present invention.

FIG. 3 depicts a more detailed view of a portion of the virtual region shown in FIG. 2 in accordance with an embodiment of the present invention.

FIG. 4 depicts a more detailed view of the virtual universe client shown in FIG. 1 in accordance with an embodiment of the present invention.

FIG. 5 depicts a more detailed view of some of the functionalities provided by the server array shown in FIG. 1 in accordance with an embodiment of the present invention.

FIG. 6 depicts a more detailed view of an avatar control tool in FIG. 5 in accordance with an embodiment of the present invention.

FIG. 7 depicts a schematic view of a remote-surrogate control service in accordance with another embodiment of the present invention.

FIG. 8A depicts a first portion of a process flow for providing surrogate avatar control in a virtual universe in accordance with an embodiment of the present invention.

FIG. 8B depicts a second portion of the process flow in FIG. 8A in accordance with an embodiment of the present invention.

FIG. 9 depicts an illustrative computer system for implementing embodiment(s) of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As detailed above, the present invention provides surrogate avatar control in a virtual universe. Aspects of the invention provide a solution to the problem of enabling one resident of the virtual universe 12 to take over the avatar of a second resident. This may be when the second resident must be away from the virtual universe 12 and wishes his/her avatar to have an intelligent presence at various virtual universe 12 settings (e.g., meeting, social setting, business, etc.). For example, the solution would allow a 24-hour store in the virtual universe 12 to be operated. Aspects of the invention allow homeowners and/or business owners to have an intelligent presence to deter crime.

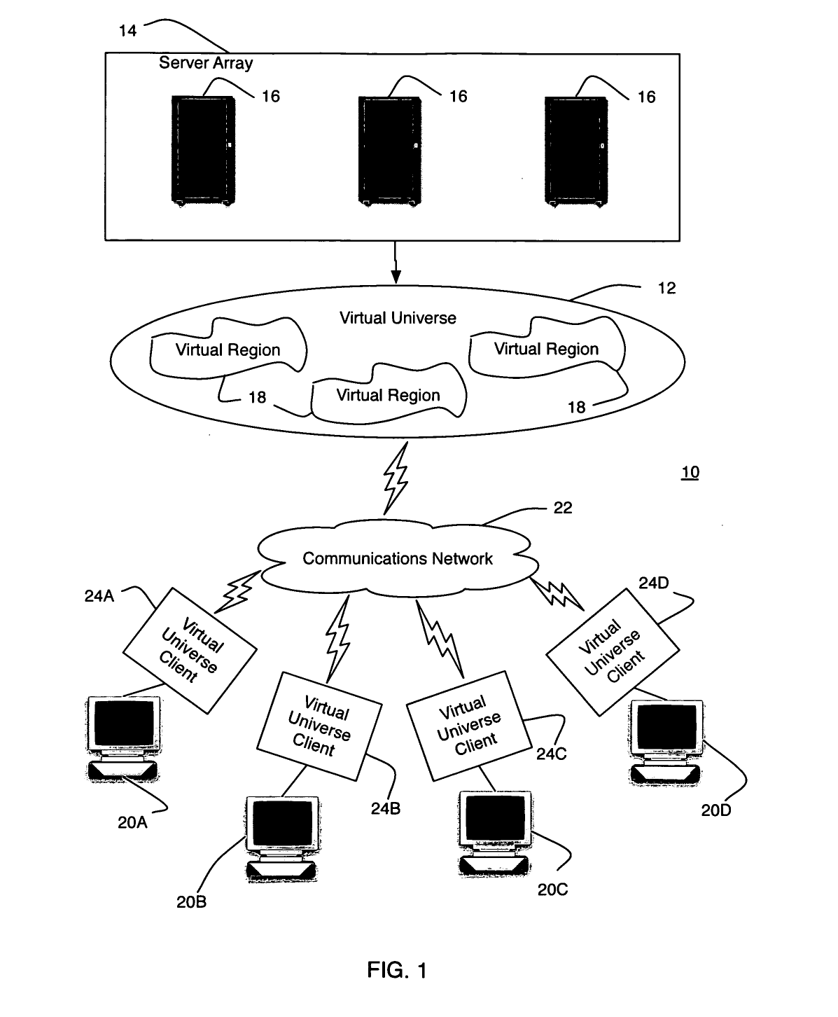

FIG. 1 shows a high-level schematic diagram showing a networking environment 10 for providing a virtual universe 12 according to one embodiment of this invention in which a service for providing surrogate avatar control in a virtual universe can be utilized. As shown in FIG. 1, the networking environment 10 comprises a server array or grid 14 comprising a plurality of servers 16 each responsible for managing a portion of virtual real estate within the virtual universe 12. A virtual universe provided by a typical massive multiplayer on-line game can employ thousands of servers to manage all of the virtual real estate. The content of the virtual real estate that is managed by each of the servers 16 within the server array 14 shows up in the virtual universe 12 as a virtual region 18. Like the real-world, each virtual region 18 within the virtual universe 12 comprises a living landscape having things such as buildings, stores, clubs, sporting arenas, parks, beaches, cities and towns all created by residents of the universe that are represented by avatars. These examples of items are only illustrative of some things that may be found in a virtual region and are not limiting. Furthermore, the number of virtual regions 18 shown in FIG. 1 is only for illustration purposes and those skilled in the art will recognize that there may be many more regions found in a typical virtual universe. FIG. 1 also shows that users operating computers 20 (e.g., 20A, 20B, 20C, 20D) interact with the virtual universe 12 through a communication network 22 via a virtual universe client 24 (e.g., 24A, 24B, 24C, 24D) that resides in the computer. Below are further details of the virtual universe 12, server array 14, and virtual universe client 24A, 24B, 24C, 24D.

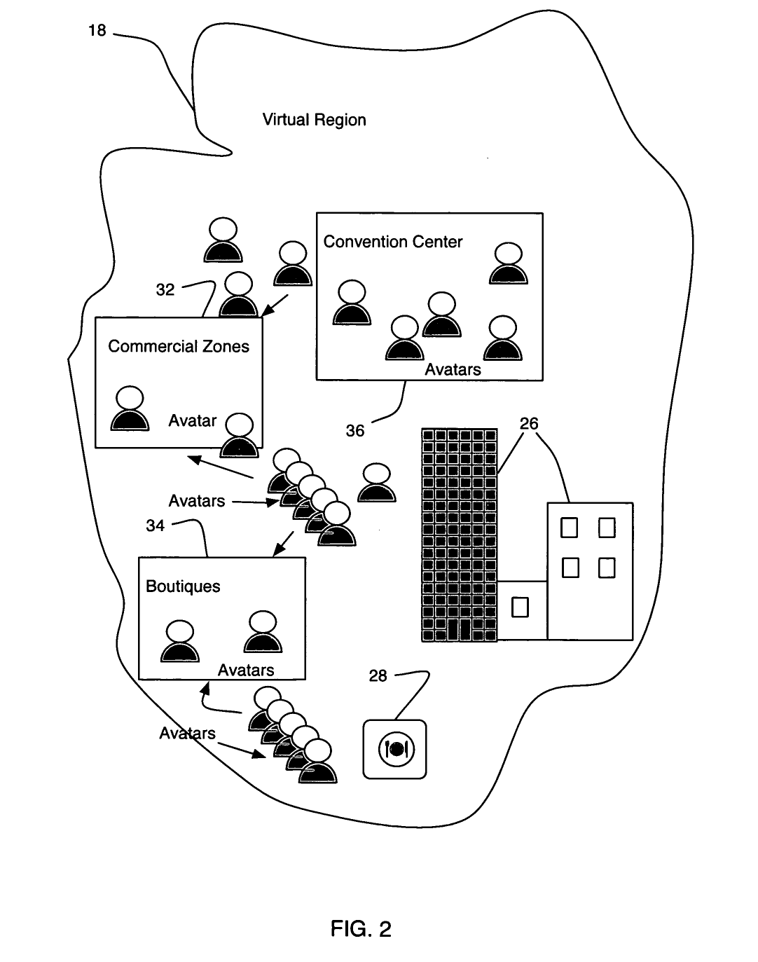

FIG. 2 shows a more detailed view of a virtual region shown 18 in the virtual universe 12 of FIG. 1 with avatars concentrated in various locations of the virtual region. As an example, the virtual region 18 shown in FIG. 2 comprises a downtown office center 26, restaurants 28 commercial zones 32 and boutiques 34 for shopping and a convention center 36 for meetings and various conventions. Also located in the virtual region 18 and/or within the various sub-elements (e.g., downtown office center 26, restaurants 28 commercial zones 32 and boutiques 34, convention center 36, etc.) may be an information location 40. These examples of items in the virtual region 18 shown in FIG. 2 are only illustrative of some things that may be found in a virtual region 18 and those skilled in the art will recognize that these regions can have many more items that can be found in a real-life universe as well as things that do not presently exist in real life.

Residents or avatars, which as mentioned above are personas or representations of the users of the virtual universe, roam all about the virtual region by walking, driving, flying or even by teleportation or transportation which is essentially moving through space from one point to another, more or less instantaneously. As shown in FIG. 2, there is a concentration of avatars in or near the convention center 36, and there are a several avatars at or near the commercial zones 32 and at the boutique 34 and none at the downtown office center 26 and restaurants 28. Several avatars and/or a group of avatars are queued up to enter the commercial zone 32 and/or the boutique 34. In any event, aspects of the method provide surrogate avatar control in a virtual universe.

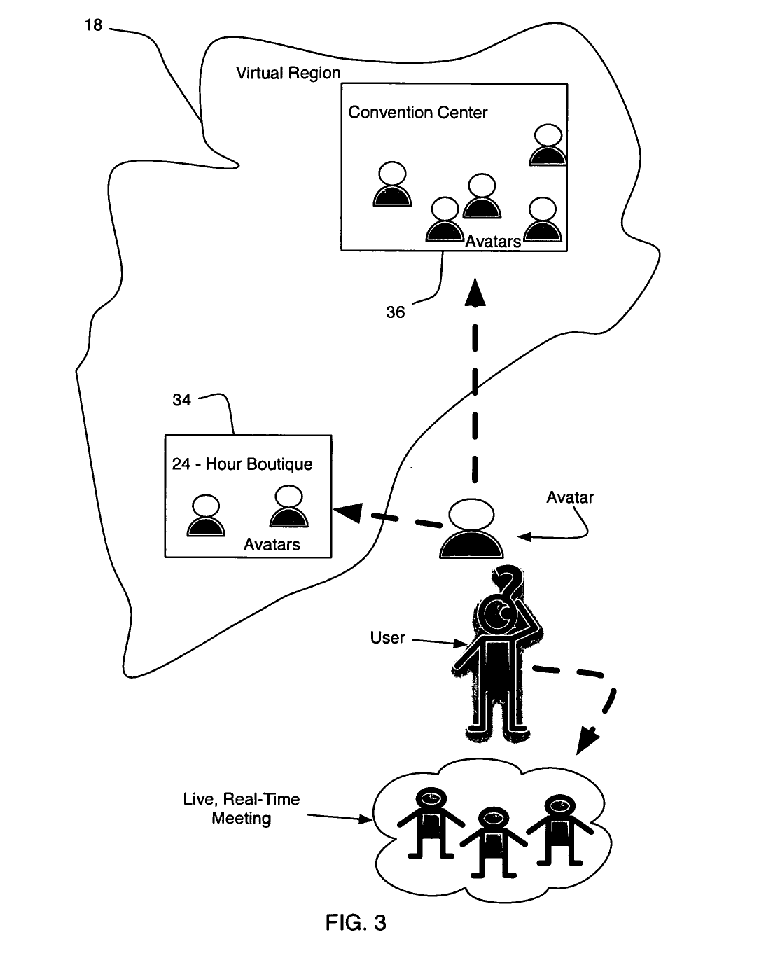

As more specifically shown in FIG. 3, an avatar, or group of avatars, may desire to be in, at, and/or near more than one location in the virtual universe 12 at, or near, the same time. For example, the avatar may wish to both conduct commerce (e.g., run a 24-hour boutique 34) and attend a gathering at the convention center 36 within the virtual universe 12. Similarly, the user (e.g., real, live human) may need to attend to something in his/her real life (i.e., non virtual universe activity) concurrently to an activity in the virtual universe 12. For example, while having the avatar attend the 24-hour boutique or the convention center 36, the user may need to attend a live, real-time meeting, as shown in FIG. 3. In any event, aspects of the invention address these various types of situations.

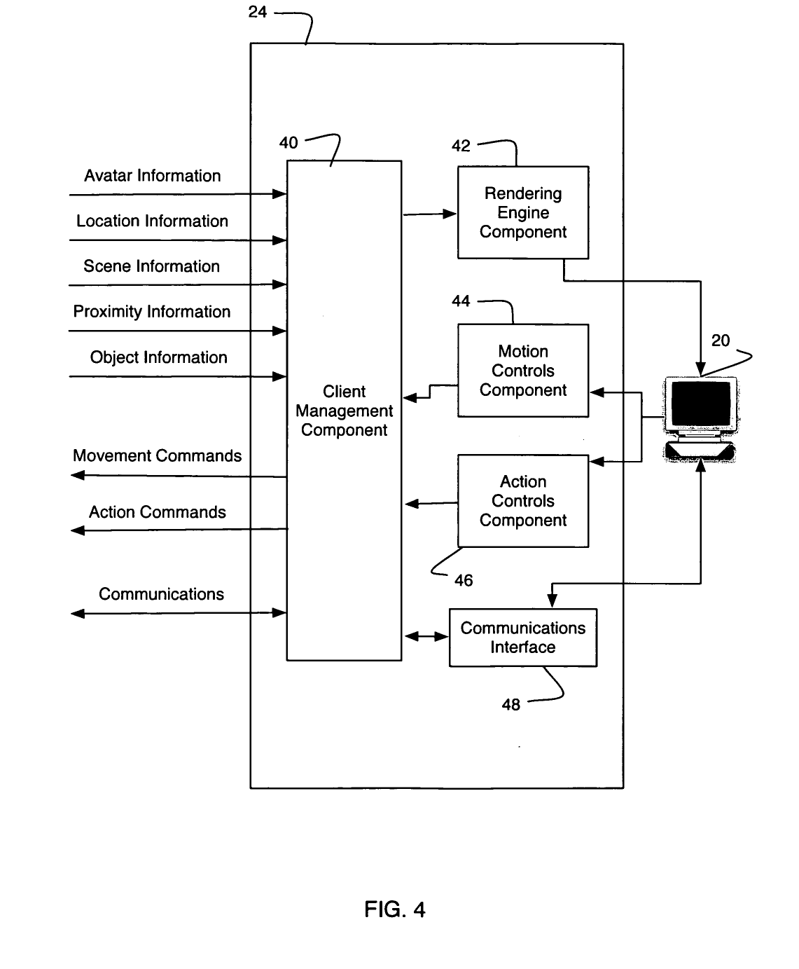

FIG. 4 shows a more detailed view of the virtual universe client 24A, 24B, 24C, 24D shown in FIG. 1. The virtual universe client 24, which enables users to interact with the virtual universe 12, comprises a client management component 40, which manages actions, movements and communications made by a user through computer 20, and information received from the virtual universe through the server array 14. A rendering engine component 42 enables the user of the computer 20 (e.g., 20A, 20B, 20C, 20D at FIG. 1) to visualize his or her avatar within the surroundings of the particular region of the virtual universe 12 that it is presently located. A motion controls component 44 enables the user to make movements through the virtual universe. In one embodiment, movements through the virtual universe can include for example, gestures, postures, walking, running, driving, flying, etc.

An action controls component 46 enables the user to perform actions in the virtual universe such as buying items for his or her avatar or even for their real-life selves, building homes, planting gardens, etc., as well as changing the appearance of their avatar. These actions are only illustrative of some possible actions that a user can perform in the virtual universe and are not limiting of the many possible actions that can be performed. A communications interface 48 enables a user to communicate with other users of the virtual universe 12 through modalities such as chatting, instant messaging, gesturing, talking and email.

FIG. 4 shows various information that may be received by the client management component 40 from the virtual universe through the server array 14. In particular, the client management component 40 receives avatar information about the avatars that are in proximity to the user's avatar. In addition, the client management component 40 receives location information about the area that the user's avatar is near (e.g., what region or island he or she is in) as well as scene information (e.g., what the avatar sees). The client management component 40 also receives proximity information which contains information on what the user's avatar is near and object information which is information that can be obtained by one's senses (e.g., touch, taste, smell, etc.,) and what actions are possible for nearby objects (e.g., postures, movements). FIG. 4 also shows the movement commands and action commands that are generated by the user that are sent to the server array via the client management component 40, as well as the communications that can be sent to the users of other avatars within the virtual universe.

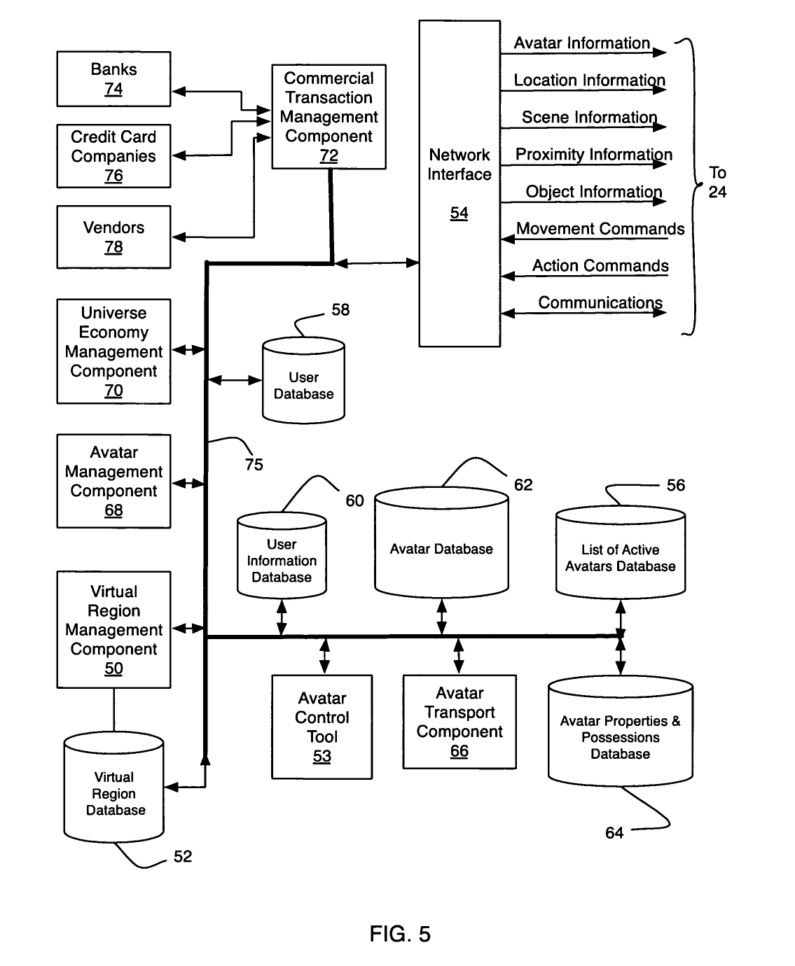

FIG. 5 shows a more detailed view of some of the functionalities provided by the server array 14 shown in FIG. 1. In particular, FIG. 5 shows a virtual region management component 50 that manages a virtual region within the virtual universe. In particular, the virtual region management component 50 manages what happens in a particular region such as the type of landscape in that region, the amount of homes, commercial zones, boutiques, bridges, highways, streets, parks, restaurants, etc. A virtual region database 52 stores information on all of the items in the virtual region 18 that the virtual region management component 50 is managing. In one embodiment, for very large virtual universes, one server 16 may be responsible for managing one particular virtual region 18 within the universe. In other embodiments, it is possible that one server 16 may be responsible for handling one particular island within the virtual region 18.

An avatar control tool 53 provides for surrogate avatar control in a virtual universe 12. Below is a more detailed discussion of the avatar control tool 53 and how it provides for surrogate avatar control within a virtual universe 12, including a discussion on how the tool 53 provides an avatar(s) in the virtual universe 12 wherein the avatar may be controlled by a first entity; and, supplies a token, or other indicia, that comprises permission for another entity to control at least one aspect of the same avatar.

FIG. 5 shows a network interface 54 that enables the server array 14 to interact with the virtual universe client 24 residing on computer 20. In particular, the network interface 54 communicates information that includes information pertaining to avatars, location, trajectory, scene, proximity and objects to the user through the virtual universe client 24 and receives movement and action commands as well as communications from the user via the universe client.

As shown in FIG. 5, there are several different databases for storing information. In particular, database 56 contains a list of all the avatars that are on-line in the virtual universe 12. Databases 58 and 60 contain information on the actual human users of the virtual universe 12. In one embodiment, database 58 contains general information on the users such as names, addresses, interests, ages, etc., while database 60 contains more private information on the users such as email addresses, billing information (e.g., credit card information) for taking part in transactions. Databases 62 and 64 contain information on the avatars of the users that reside in the virtual universe 12. In one embodiment, database 62 contains information such as all of the avatars that a user may have, the profile of each avatar, avatar characteristics (e.g., appearance, voice and movement features), while database 64 contains an inventory listing properties and possessions that each avatar owns such as houses, cars, sporting equipment, appearance, attire, etc. Those skilled in the art will recognize that databases 58-64 may contain additional information if desired. Although the above information is shown in FIG. 5 as being stored in databases, those skilled in the art will recognize that other means of storing information can be utilized.

An avatar transport component 66 enables individual avatars to transport, which as mentioned above, allows avatars to transport through space from one point to another point, instantaneously. For example, avatars could teleport to an art exhibit held in a museum held in Greenland.

An avatar management component 68 keeps track of what on-line avatars are doing while in the virtual universe. For example, the avatar management component 68 can track where the avatar presently is in the virtual universe, what activities it is performing or has recently performed. An illustrative but non-exhaustive list of activities can include shopping, eating, talking, recreating, etc.

Because a typical virtual universe has a vibrant economy, the server array 14 has functionalities that are configured to manage the economy. In particular, a universe economy management component 70 manages transactions that occur within the virtual universe between avatars. In one embodiment, the virtual universe 12 will have their own currency that users pay for with real-life money. The users can then take part in commercial transactions for their avatars through the universe economy management component 70. In some instances, the user may want to take part in a commercial transaction that benefits him or her and not their avatar. In this case, a commercial transaction management component 72 allows the user to participate in the transaction. For example, while walking around a commercial zone, an avatar may see a pair of shoes that he or she would like for themselves and not their avatar. In order to fulfill this type of transaction and others similarly related, the commercial transaction management component 72 interacts with banks 74, credit card companies 76 and vendors 78 to facilitate such a transaction.

The components in FIG. 5 are all interconnected via an interconnect 75. Although shown in FIG. 5 as connected via interconnect 75, all of the components may be configured to interact with each other using other means now known or later developed. The components that are shown as being interconnected via interconnect 75 are illustrated in that manner to convey the close interactions that exist between these components such as the banks 74, credit card companies 76, and vendors with the commercial transaction management component 72.

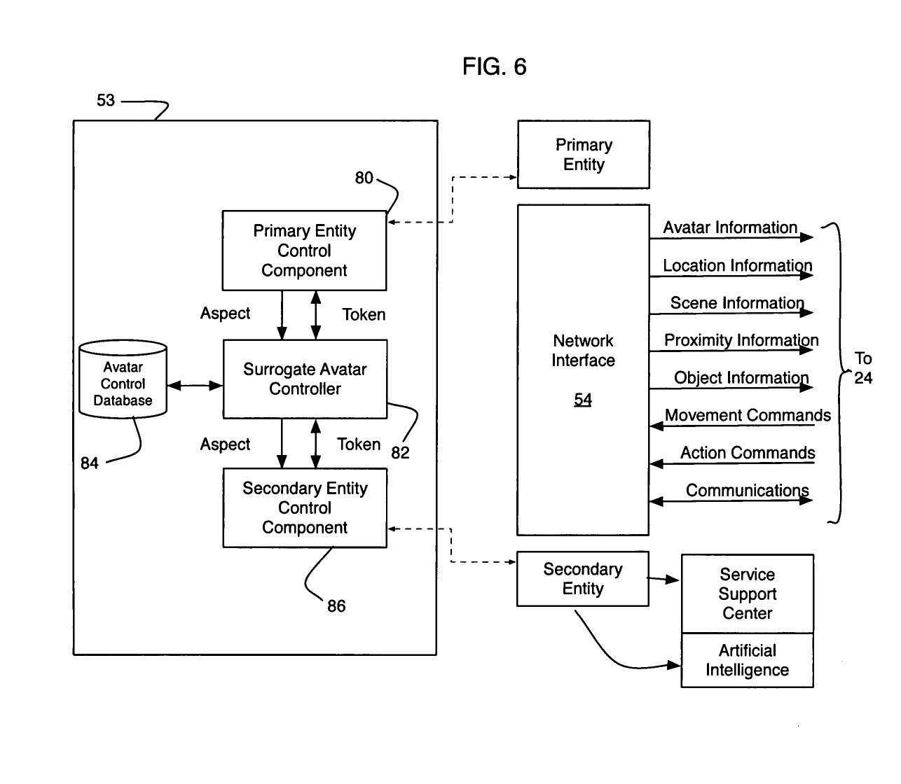

FIG. 6 shows a more detailed view of an avatar control tool 53 shown in FIG. 5 according to one embodiment of this invention. As mentioned above, the avatar control tool 53 provides for surrogate avatar control within a virtual universe 12. As shown in FIG. 6, in one embodiment, the avatar control tool 53 resides on a computer system that is a part of the server array 14 and communicates directly to the virtual universe and its residents via the virtual universe client 24. In other embodiments, the avatar control tool 53 might reside on separate computers in direct communication with the virtual universe servers 16 and universe clients 24.

The avatar control tool 53 comprises a primary entity control component 80 configured to provide an interface with a first, or primary, entity that is controlling the avatar. The first entity may, for example, be a user (e.g., live, real human being). The first entity typically controls all aspects of the avatar. The aspects may include, for example, the avatar's gestures, recording, utterances, ability to move, teleport, remove items, purchase items, and/or the like.

A surrogate avatar controller 82 is configured to supply tokens, wherein the token comprises a permission for a second entity to control at least one aspect of the avatar. The aspects comprise, for example, the avatar's gestures, recording, utterances, ability to move, teleport, remove items, purchase items, and/or the like. The token(s) may be supplied and/or received from a primary user via the primary entity control component 80 and/or supplied and/or received from a secondary entity via the secondary entity control component 86.

The avatar control database 84 coupled to the surrogate avatar controller 82 contains data such as a listing of users and their concomitant avatars, a listing of various secondary entities that are allowed surrogate control of an aspect of the avatar, a listing of what aspect(s) of the avatar correspond to what particular secondary entity (e.g., surrogate) for control, a listing of what other avatars

The avatar control tool 53 further comprises a secondary entity control component 86 configured to interface between the surrogate avatar controller 82 and at least one of the secondary entities. The secondary entity may be an individual user (e.g., human), an artificial intelligence entity, a service support center, a plurality of users, and/or the like.

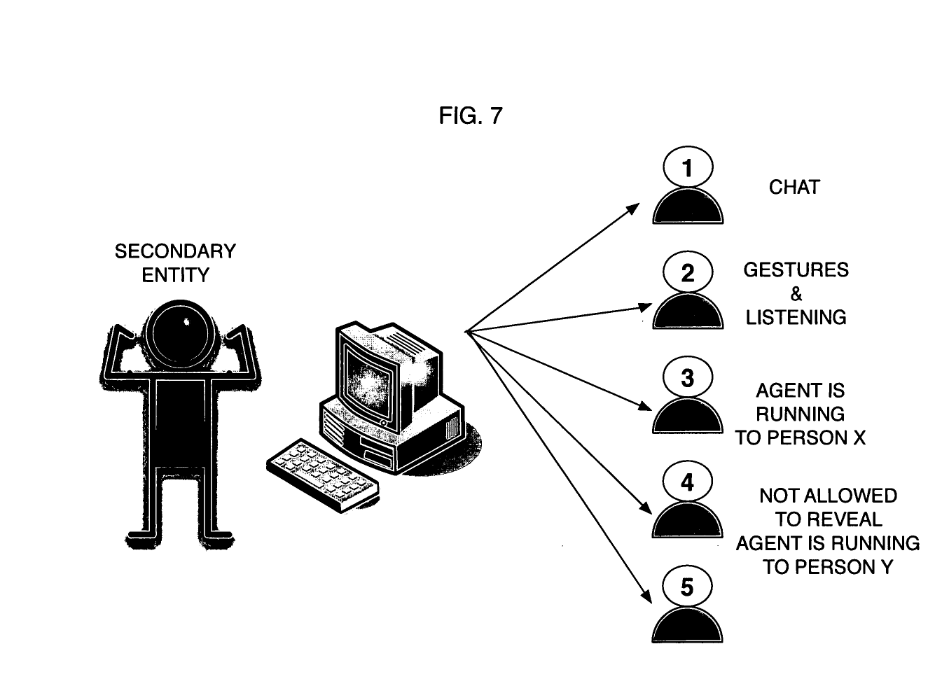

In an embodiment the avatar control tool 54 may include, a service support center that allows a surrogate control specialist to take over control aspects of many avatars. For example, as shown in FIG. 7, a single specialist may view the avatar's status, handle their chats, and/or the like. This control may be done by an automated machine (e.g., artificial intelligence devie) or it may be done by a skilled person such as a person in an avatar-control service who uses a multiple-window GUI to control several avatars. As depicted in FIG. 7, a single user (“secondary entity”) is controlling aspects of a five (5) separate avatars. The secondary entity can control the first avatar (“1”) and the ability to chat. Similarly, the secondary entity can control the second avatar (“2”) and the ability to control gestures and listening. The secondary entity can control the third avatar (“3”) and is only allowed the ability to reveal that the secondary entity (agent) is running to person X. The secondary entity can control the fourth avatar (“4”) and is not allowed to reveal that the agent is running to person Y. Finally, the secondary entity may have full control of all aspects of the fifth avatar (“5”). It should be apparent, that a near infinite variety of control permutations and quantity of avatars under control by the secondary entity are available under aspects of the present invention.

In another embodiment, an indicia may be provided with the avatar indicating that the avatar is being controlled by the secondary entity. This indicia may be selectively employed, depending on the particular avatar and/or secondary entity is being given control of the avatar. For example, the indicia may be a change in an aspect of the avatar (e.g., color, size, shading, etc.), an indicator (e.g., words, icon, light, signage, etc.), and/or the like. Similarly, the primary entity whose avatar is being controlled by the secondary entity may have, for example, a list of people who would see an icon above the avatar's head that indicates the avatar had been taken over by the secondary entity. This aspect could prevent the person's boss from knowing that someone from knowing that someone was covering for him/her at a meeting. However, if the controlled avatar meets a friend, the friend is warned, via the indicia, that he should not disclose personal data that he/she might not want the surrogate control takeover specialist to know.

In another embodiment, the avatar control tool 53 includes an aspect to prevent remote takeover by malicious residents who wish to create zombies and impersonations. In this embodiment, each avatar has associated metadata which allows or disallows remote control by specific individuals and/or services. This security aspects may be password protected. A sample table listing various security settings that may be stored in the avatar control database 84 is depicted herein at Table 1:

| | | | Removed | | | |
|---|---|---|---|---|---|---|
| | Remote | | Items | | | |
| | Control | | From | | Control | |
| | Enabled | Control Level | Inventory? | Teleported? | given to: | Time |
| Avatar 1 | Yes | Avatar | No | No | Friend 1 | 2 am-6 am |
| | | presence | | | and | |
| | | but not | | | Friend 2 | |
| | | chat | | | | |
| Avatar 2 | Yes | Chat | Yes | Yes | | 3 am-6 am |
| | | w/avatar | | | | |
| | | 27 only | | | | |
| Avatar 3 | No | | | | | |
| Avatar 4 | Yes | gestures | Yes | No | | 5 am-6 am |

As depicted in Table 1, four avatars (i.e., Avatar 1, Avatar 2, Avatar 3, Avatar 4) are listed for surrogate avatar control to some degree. For example, remote control of the avatar has been enabled (i.e., 1^{st} column) for Avatars 1, 2 and 4; but, not for Avatar 3. The control level (or an aspect(s) of the avatar) has been transferred to the secondary entity. For Avatar 1, the secondary entity is allowed to control the avatar's presence but not chat. Avatar 2 is only allowed to chat with Avatar 27 (not shown). Avatar 4 is able to have gestures. The 5^{th} column shows that only Avatar 2 has teleporting capability. Similarly, the 6^{th} column shows that surrogate control for Avatar 1 is given only the Friend 1 and 2; for Avatar 2 is given to an avatar service center in Bangalore, India; while, Avatar 4 allows only a spouse to exert surrogate control. The final (i.e., 7^{th}) column indicates what times that the applicable surrogate control is allowed.

Under aspects of the present invention a resident (i.e., primary or first) entity) of a virtual universe 12 community passes control of his/her personal avatar (e.g., an aspect, several aspects, entire control, etc.) to a surrogate avatar control entity (i.e., secondary entity). There are a variety of ways of transferring control. For example, a resident may send a signal to another resident to request takeover by that resident or by a remote takeover service. Alternatively, a second resident may issue a digital command to the avatar of the first resident to initiate takeover, after the first resident has given permission. Still alternatively, the transfer of control may entail passing a permission token containing an identification label and a password, or may include more complex information such as the avatar control database 84 containing a profile or description of the avatar design and personal response characteristics.

In another embodiment, a first or primary entity sends a signal to an avatar control center (i.e., service support center at FIG. 6), giving permission for the center's personnel to take control. The service support center receives the signal which may containing information on the avatar, duration for the takeover, various specification as to the level of takeover, and/or the like. The service support center sends a signal back to the resident confirming receipt of the signal request. Money may be charged for the duration and/or level of takeover. Additionally, passwords may be used for additional authentication. All chats and information exchange may be saved by the service support center and sent to the primary entity as requested (e.g., when the takeover session has ended, periodic updates, etc.). Additionally, certain emergency conditions may be given by the primary entity so that the surrogate may know how to respond or contract the real-life user of the avatar, as needed.

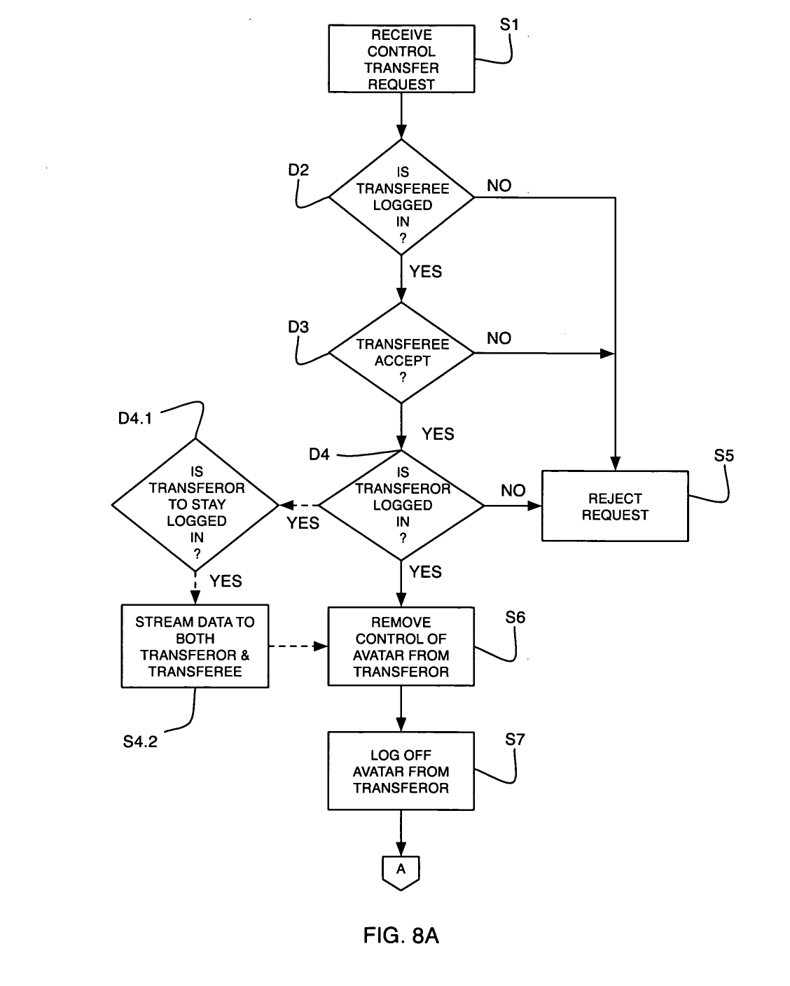

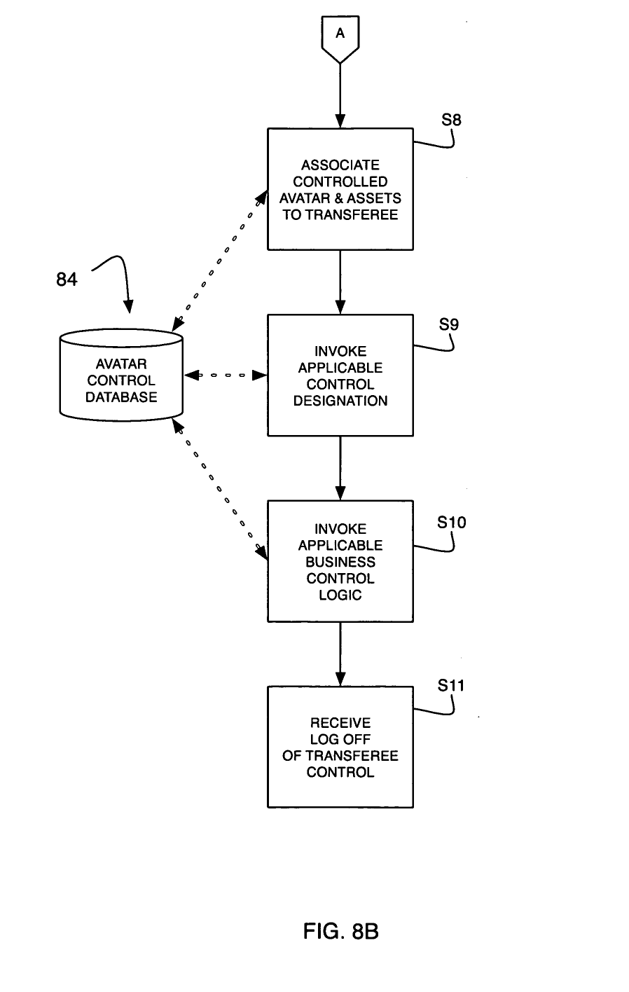

Referring to FIGS. 8A and 8B, which depict an embodiment of a method of providing surrogate avatar control in a virtual universe 12. As discussed herein an avatar and/or the user controlling the avatar may have a conflict or need for assistance in controlling the avatar due to a variety of reasons. In any event at S1 a virtual universe grid receives a request to transfer avatar control from the user of the avatar to another entity. For example, as discussed herein, the request may be accompanied by receipt of a permission token receipt by the entity (i.e., transferee).

At D2, the system verifies if the transferee (i.e., second entity, surrogate controller, etc.) is logged in. If the transferee is not logged in (i.e., D2 is “NO”), at S5 the request for transfer is rejected, thereby ending the method. Conversely, if the transferee is logged in (i.e., D2 is “YES”), then the method proceeds to D3. D3 queries the transferee (i.e., entity to receive control) whether he/she is willing to accept to control. As with D2 (above), if the transferee is unwilling to accept control of the avatar (i.e., D3 is “NO”), then at S5 the request for transfer is rejected, thereby ending the method. Similarly, if the transferee is willing to accept control of the avatar (i.e., D3 is “YES”), then at D4 the method queries if the transferee is logged in.

At D4 the method queries whether the transferee is logged. If the transferee is not logged in (i.e., D4 is “NO”), then at S5 the request for control transfer is rejected, thereby ending the method. Conversely, if the transferee is logged in (i.e., D4 is “YES”), then at S6 control of avatar and/or assets is removed from the transferor.

In an embodiment, an optional subprocess may exist at D4.1 and S4.2. This subprocess may be invoked if the transferor is logged in (i.e., D4 is “YES”) and includes at D4.1 querying if the transferor opts to remain logged in. If the transferor is to remain logged in (i.e., D4.1 is “YES”), then transferor is left logged in with geometries (e.g., coordinate date) and textures (e.g., graphic files) from the avatar's perspective. In other words, although control of the avatar will transfer to the transferee, the transferor may still be able to view the virtual universe 12 from the avatar's perspective. In this mode, at S4.2 the same data may be streamed to both transferor and transferee.

At S7, log off the avatar and assets for the user who is receiving the avatar control (i.e., transferee). This allows the system to maintain a one-to-one relationship of avatar to user. In another embodiment, multiple avatar windows are allowed thereby allowing multiple avatars to be controlled by a single entity. In this embodiment, S6 may be replaced with a separate avatar window creation step.

Continuing with FIG. 8B at S8 the method includes associating in the avatar control database 84 the controlled avatar and any allowed assets to the transferee. A new table and/or files may be added to the avatar control database 84 to contain this temporary status information. At S9, if applicable, any control designation is invoked, from the avatar control database 84, so as to ensure others in the virtual universe 12 know that the avatar is not being controlled by its owning user. At S10 any applicable business control logic is invoked, from the avatar control database 84, for the duration of the takeover session so as to ensure that the transferee may not use the avatar or its assets in a way that would violate the business logic For example, the business logic may include restrictions on how much virtual universe 12 currency may be spent; how the virtual universe 12 currency is spent; who the avatar may chat with; and/or the like. A new table and/or fields may be added to the avatar control database 84 that contains this business logic along with an interface for users to create custom rules. At S11 the system receives a log off of the transferee's control of the avatar. For example, evidence of the log off may be a virtual universe 12 client exit, an affirmative request to no longer exhibit control of the avatar, a log in of the avatar's owning user (e.g., transferor). Upon the receipt of the log off, the previous steps may be reversed, thereby fully returning control of the avatar from the transferee back to the transferor. In any event, the method provides for the surrogate control of at least one avatar in the virtual universe 12.

In another embodiment of this invention, the avatar control tool 53 is used as a service to charge fees for each user, or group of users, that seeks help in obtaining surrogate avatar control in a virtual universe. In this embodiment, the provider of the virtual universe or a third party service provider could offer this avatar control tool 53 as a service by performing the functionalities described herein on a subscription and/or fee basis. In this case, the provider of the virtual universe or the third party service provider can create, deploy, maintain, support, etc., the avatar control tool 53 that performs the processes described in the invention. In return, the virtual universe or the third party service provider can receive payment from the virtual universe residents via the universe economy management component 70 and the commercial transaction management component 72.

In still another embodiment, the methodologies disclosed herein can be used within a computer system to provide surrogate avatar control in a virtual universe. In this case, the avatar control tool 53 can be provided and one or more systems for performing the processes described in the invention can be obtained and deployed to a computer infrastructure. To this extent, the deployment can comprise one or more of (1) installing program code on a computing device, such as a computer system, from a computer-readable medium; (2) adding one or more computing devices to the infrastructure; and (3) incorporating and/or modifying one or more existing systems of the infrastructure to enable the infrastructure to perform the process actions of the invention.

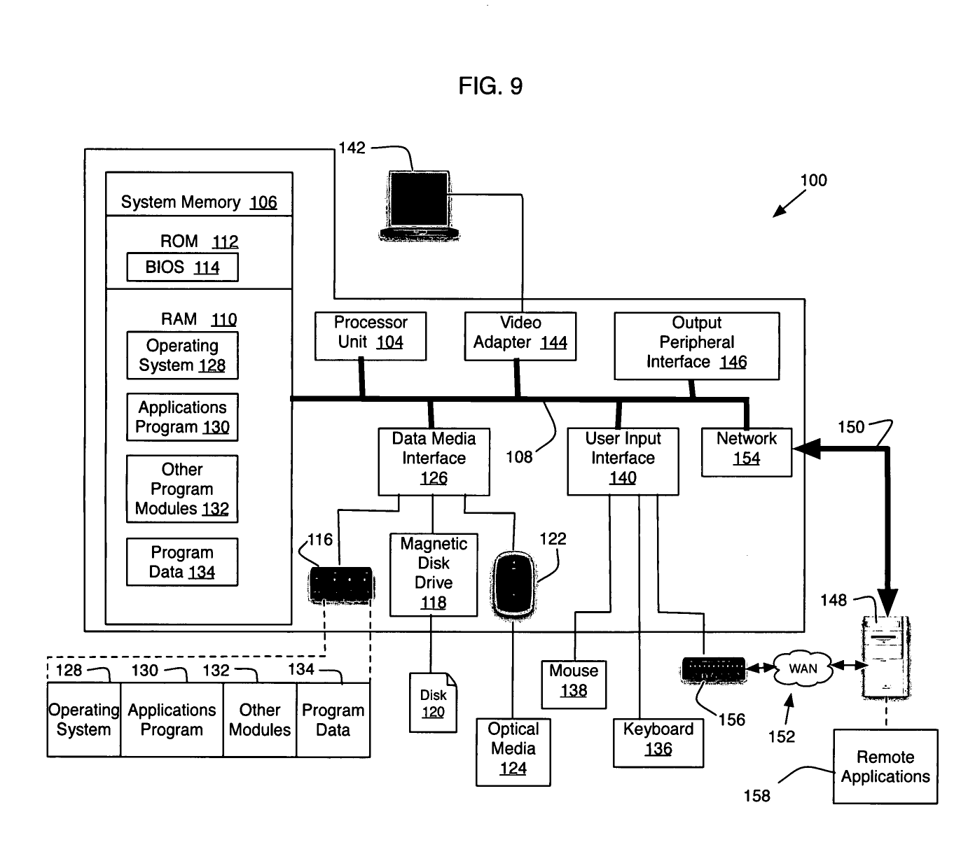

FIG. 9 shows a schematic of an exemplary computing environment in which elements of the networking environment shown in FIG. 1 may operate. The exemplary computing environment 100 is only one example of a suitable computing environment and is not intended to suggest any limitation as to the scope of use or functionality of the approach described herein. Neither should the computing environment 100 be interpreted as having any dependency or requirement relating to any one or combination of components illustrated in FIG. 9.

In the computing environment 100 there is a computer 102 which is operational with numerous other general purpose or special purpose computing system environments or configurations. Examples of well known computing systems, environments, and/or configurations that may be suitable for use with an exemplary computer 102 include, but are not limited to, personal computers, server computers, thin clients, thick clients, hand-held or laptop devices, multiprocessor systems, microprocessor-based systems, set top boxes, programmable customer electronics, network PCs, minicomputers, mainframe computers, distributed computing environments that include any of the above systems or devices, and the like.

The exemplary computer 102 may be described in the general context of computer-executable instructions, such as program modules, being executed by a computer. Generally, program modules include routines, programs, objects, components, logic, data structures, and so on, that performs particular tasks or implements particular abstract data types. The exemplary computer 102 may be practiced in distributed computing environments where tasks are performed by remote processing devices that are linked through a communications network. In a distributed computing environment, program modules may be located in both local and remote computer storage media including memory storage devices.

As shown in FIG. 9, the computer 102 in the computing environment 100 is shown in the form of a general-purpose computing device. The components of computer 102 may include, but are not limited to, one or more processors or processing units 104, a system memory 106, and a bus 108 that couples various system components including the system memory 106 to the processor 104.

Bus 108 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 102 typically includes a variety of computer readable media. Such media may be any available media that is accessible by computer 102, and it includes both volatile and non-volatile media, removable and non-removable media.

In FIG. 9, the system memory 106 includes computer readable media in the form of volatile memory, such as random access memory (RAM) 110, and/or non-volatile memory, such as ROM 112. A BIOS 114 containing the basic routines that help to transfer information between elements within computer 102, such as during start-up, is stored in ROM 112. RAM 110 typically contains data and/or program modules that are immediately accessible to and/or presently operated on by processor 104.

Computer 102 may further include other removable/non-removable, volatile/non-volatile computer storage media. By way of example only, FIG. 9 illustrates a hard disk drive 116 for reading from and writing to a non-removable, non-volatile magnetic media (not shown and typically called a “hard drive”), a magnetic disk drive 118 for reading from and writing to a removable, non-volatile magnetic disk 120 (e.g., a “floppy disk”), and an optical disk drive 122 for reading from or writing to a removable, non-volatile optical disk 124 such as a CD-ROM, DVD-ROM or other optical media. The hard disk drive 116, magnetic disk drive 118, and optical disk drive 122 are each connected to bus 108 by one or more data media interfaces 126.

The drives and their associated computer-readable media provide nonvolatile storage of computer readable instructions, data structures, program modules, and other data for computer 102. Although the exemplary environment described herein employs a hard disk 116, a removable magnetic disk 118 and a removable optical disk 122, it should be appreciated by those skilled in the art that other types of computer readable media which can store data that is accessible by a computer, such as magnetic cassettes, flash memory cards, digital video disks, RAMs, ROM, and the like, may also be used in the exemplary operating environment.

A number of program modules may be stored on the hard disk 116, magnetic disk 120, optical disk 122, ROM 112, or RAM 110, including, by way of example, and not limitation, an operating system 128, one or more application programs 130 (e.g., primary entity control component 80, surrogate avatar controller 82, secondary entity control component 86, etc.), other program modules 132, and program data 134. Each of the operating system 128, one or more application programs 130 (e.g., primary entity control component 80, surrogate avatar controller 82, secondary entity control component 86, etc.), other program modules 132, and program data 134 or some combination thereof, may include an implementation of the networking environment 10 of FIG. 1 including the server array 14, the virtual universe client 24 and the avatar control tool 53.

A user may enter commands and information into computer 102 through optional input devices such as a keyboard 136 and a pointing device 138 (such as a “mouse”). Other input devices (not shown) may include a microphone, joystick, game pad, satellite dish, serial port, scanner, camera, or the like. These and other input devices are connected to the processor unit 104 through a user input interface 140 that is coupled to bus 108, but may be connected by other interface and bus structures, such as a parallel port, game port, or a universal serial bus (USB).

An optional monitor 142 or other type of display device is also connected to bus 108 via an interface, such as a video adapter 144. In addition to the monitor, personal computers typically include other peripheral output devices (not shown), such as speakers and printers, which may be connected through output peripheral interface 146.

Computer 102 may operate in a networked environment using logical connections to one or more remote computers, such as a remote server/computer 148. Remote computer 148 may include many or all of the elements and features described herein relative to computer 102.

Logical connections shown in FIG. 9 are a local area network (LAN) 150 and a general wide area network (WAN) 152. Such networking environments are commonplace in offices, enterprise-wide computer networks, intranets, and the Internet. When used in a LAN networking environment, the computer 102 is connected to LAN 150 via network interface or adapter 154. When used in a WAN networking environment, the computer typically includes a modem 156 or other means for establishing communications over the WAN 152. The modem, which may be internal or external, may be connected to the system bus 108 via the user input interface 140 or other appropriate mechanism.

In a networked environment, program modules depicted relative to the personal computer 102, or portions thereof, may be stored in a remote memory storage device. By way of example, and not limitation, FIG. 9 illustrates remote application programs 158 as residing on a memory device of remote computer 148. It will be appreciated that the network connections shown and described are exemplary and other means of establishing a communications link between the computers may be used.

An implementation of an exemplary computer 102 may be stored on or transmitted across some form of computer readable media. Computer readable media can be any available media that can be accessed by a computer. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

It is apparent that there has been provided with this invention an approach for providing surrogate avatar control in a virtual universe. While the invention has been particularly shown and described in conjunction with a preferred embodiment thereof, it will be appreciated that variations and modifications will occur to those skilled in the art. Therefore, it is to be understood that the appended claims are intended to cover all such modifications and changes as fall within the true spirit of the invention.

What is claimed is:

1. A method for controlling an avatar in a virtual universe, comprising:
providing an avatar in a virtual universe, wherein the avatar is controlled by a first entity; and
supplying a token, wherein the token comprises a permission for a second entity to control an aspect of the avatar.

2. The method of claim 1, wherein the second entity is at least one of artificial intelligence and a service support center.

3. The method of claim 1, wherein the aspect is at least one of: a gesture, a recording, an utterance, an ability to teleport, a movement, and an ability to remove items from inventory.

4. The method of claim 1, further comprising:
displaying activities of the avatar on a graphical user interface (GUI).

5. The method of claim 1, the providing further comprising providing a plurality of avatars; and
the supplying further comprising supplying the second entity a plurality of tokens, wherein each token comprises a permission for the second entity to control an aspect of each of the plurality of avatars.

6. The method of claim 1, further comprising indicating that the avatar is controlled by the second entity.

7. The method of claim 1, further comprising receiving a request from the first entity to take control of the avatar by the second entity.

8. The method of claim 1, further comprising receiving the token from the second entity.

9. The method of claim 1, upon the receiving further comprising issuing a digital command from the second entity to take over the avatar.

10. A system for controlling an avatar in a virtual universe, comprising:
a component for providing an avatar in a virtual universe, wherein the avatar is controlled by a first entity; and
a component for supplying a token, wherein the token comprises a permission for a second entity to control an aspect of the avatar.

11. The system of claim 10, wherein the second entity is at least one of artificial intelligence and a service support center.

12. The system of claim 10, wherein the aspect is at least one of: a gesture, a recording, an utterance, an ability to teleport, a movement, and an ability to remove items from inventory.

13. The system of claim 10, further comprising:
a component for displaying activities of the avatar on a graphical user interface (GUI).

14. The system of claim 10, the providing further comprising a component for providing a plurality of avatars; and
the supplying component further comprising a component for supplying the second entity a plurality of tokens, wherein each token comprises a permission for the second entity to control an aspect of each of the plurality of avatars.

15. The system of claim 10, further comprising a component for indicating that the avatar is controlled by the second entity.

16. A program product stored on a computer readable medium, which when executed, controls an avatar in a virtual universe, the computer readable medium comprising program code for:
providing an avatar in a virtual universe, wherein the avatar is controlled by a first entity; and
supplying a token, wherein the token comprises a permission for a second entity to control an aspect of the avatar.

17. The program product of claim 16, wherein the second entity is at least one of artificial intelligence and a service support center.

18. The program product of claim 16, wherein the aspect is at least one of: a gesture, a recording, an utterance, an ability to teleport, a movement, and an ability to remove items from inventory.

19. The program product of claim 16, further comprising program code for:
displaying activities of the avatar on a graphical user interface (GUI).

20. The program product of claim 16, further comprising program code for:
providing a plurality of avatars; and
the supplying further comprising supplying the second entity a plurality of tokens, wherein each token comprises a permission for the second entity to control an aspect of each of the plurality of avatars.

21. The program product of claim 16, further comprising program code for:
indicating that the avatar is controlled by the second entity.

22. The program product of claim 16, further comprising program code for:
receiving a request from the first entity to take control of the avatar by the second entity.

23. The program product of claim 16, further comprising program code for:
receiving the token from the second entity.

24. The program product of claim 16, further comprising program code for:
upon the receiving, issuing a digital command from the second entity to take over the avatar.

25. A method for deploying an application for controlling an avatar in a virtual universe comprising: providing a computer infrastructure being operable to:
provide an avatar in a virtual universe, wherein the avatar is controlled by a first entity; and
supply a token, wherein the token comprises a permission for a second entity to control an aspect of the avatar.
